(19) United States
(12) Patent Application Publication
(10) Pub. No.: US 2025/0179370 A1
(43) Pub. Date: Jun. 5, 2025

(54) PHENYL POLYHEDRAL OLIGOMERIC SILSESQUIOXANE COMPOSITE MATERIALS AND USES THEREOF

(71) Applicant: The Governors of the University of Alberta, Edmonton (CA)

(72) Inventors: Aman ULLAH, Edmonton (CA); Yanet RODRIGUEZ HERRERO, Edmonton (CA)

(21) Appl. No.: 18/962,943

(22) Filed: Nov. 27, 2024

Related U.S. Application Data
(60) Provisional application No. 63/604,369, filed on Nov. 30, 2023.

(51) Int. Cl. C10G 1/06; B01J 8/00; B01J 8/22; C10G 1/08

(52) U.S. Cl. CPC C10G 1/065; C10G 1/083; B01J 8/0065; B01J 8/22

(57) ABSTRACT

Herein provided are composite materials comprising a phenyl polyhedral oligomeric silsesquioxane (POSS) and one or more metals. The composite materials may contain metal oxides, such as copper and zinc oxide. The composite materials may be used for catalysis, such as in CO₂ hydrogenation. Methods of forming and using the composite materials are also provided.

### FIELD

The present disclosure relates generally to composite materials. More particularly, the present disclosure relates to metal-loaded phenyl polyhedral oligomeric silsesquioxanes.

### BACKGROUND

Developing thermally stable heterogeneous catalysts that can endure elevated temperatures in corrosive and reductive environments is of great interest for the industrial processes. Nevertheless, active metal sites tend to sinter or coalescence into larger particles under harsh conditions, especially at high temperatures, leading to catalyst deactivation. Furthermore, support materials are used to produce a high surface area and carefully selected to tailor particular systems and thermal stability, as the support could accelerate the sintering through phase transformation or structural collapse of the support. Even though the temperature is the primary parameter in the sintering process, reaction atmospheres can also impact the rate of catalyst deactivation. Water vapor, in particular, exacerbates the crystallization and structural modification of oxide supports.

It is, therefore, desirable to provide a thermally stable support that is resistant to water deactivation, extending the catalytic system's productive life.

### SUMMARY

It is an object of the present disclosure to obviate or mitigate at least one disadvantage of previous composite materials used for catalysis.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIGS. 1A and 1B: The chemical structure of (FIG. 1A) O-POSS and (FIG. 1B) D-POSS.

FIGS. 2A-2D: graphs showing the TGA, DTG, and DSC of (FIG. 2A) O-POSS, (FIG. 2B) CuZn10-O-POSS90, (FIG. 2C) CuZn20-O-POSS80, and (FIG. 2D) CuZn30-O-POSS70 in N₂ (50 mL min⁻¹).

FIGS. 3A-3D: graphs showing the TGA and DTG of (FIG. 3A) O-POSS, (FIG. 3B) CuZn10-O-POSS90, (FIG. 3C) CuZn20-O-POSS80, and (FIG. 3D) CuZn30-O-POSS70 in an air (50 mL min⁻¹).

FIGS. 4A-4D: graphs showing the ATR-FTIR of the residues of (FIG. 4A) O-POSS, (FIG. 4B) CuZn10-O-POSS90, (FIG. 4C) CuZn20-O-POSS80, and (FIG. 4D) CuZn30-O-POSS70 in N₂ (50 mL min⁻¹).

FIGS. 5A-5D: graphs showing the ATR-FTIR of the residues (FIG. 5A) O-POSS, (FIG. 5B) CuZn10-O-POSS90, (FIG. 5C) CuZn20-O-POSS80, and (FIG. 5D) CuZn30-O-POSS70 in air (50 mL min⁻¹).

FIGS. 6A-6D: graphs showing the XRD profiles of samples heated at different temperatures (FIG. 6A) O-POSS, (FIG. 6B) CuZn10-O-POSS90, (FIG. 6C) CuZn20-O-POSS80, and (FIG. 6D) CuZn30-OPOSS70 in N₂ (50 mLmin⁻¹).

FIG. 7 is a graph showing the XRD of the residues of O-POSS and the composites of TGA at 900° C. in an air (50 mL min⁻¹).

FIGS. 8A-8D: graphs showing the TGA, DTG, and DSC of (FIG. 8A) D-POSS, (FIG. 8B) CuZn10-D-POSS90, (FIG. 8C) CuZn20-D-POSS80, and (FIG. 8D) CuZn30-D-POSS70 in N₂ (50 mL min⁻¹).

FIGS. 9A-9D: graphs showing the TGA and DTG of (FIG. 9A) D-POSS, (FIG. 9B) CuZn10-D-POSS90, (FIG. 9C) CuZn20-D-POSS80, and (FIG. 9D) CuZn30-D-POSS70 in air (50 mL min⁻¹).

FIGS. 10A-10D: graphs showing the ATR-FTIR of the residues of (FIG. 10A) D-POSS, (FIG. 10B) CuZn10-D-POSS90, (FIG. 10C) CuZn20-D-POSS80, and (FIG. 10D) CuZn30-D-POSS70 in N₂ (50 mL min⁻¹).

FIGS. 11A-11D: graphs showing the ATR-FTIR of the residues of (FIG. 11A) D-POSS, (FIG. 11B) CuZn10-D-POSS90, (FIG. 11C) CuZn20-D-POSS80, and (FIG. 11D) CuZn30-D-POSS70 in air (50 mL min⁻¹).

FIGS. 12A-12D: graphs showing the heating profile of XRD of (FIG. 12A) D-POSS, (FIG. 12B) CuZn10-D-POSS90, (FIG. 12C) CuZn20-D-POSS80, and (FIG. 12D) CuZn30-D-POSS70 in nitrogen flow of 50 mL min⁻¹.

FIG. 13 is a graph showing the XRD of the residues of D-POSS and the composites from TGA at 900° C. in air (50 mL min⁻¹).

FIG. 14 is a schematic diagram of the mechanism of methanol synthesis and the formate route.

FIGS. 15A-15B: a schematic diagram of (FIG. 15A) the stainless steel microbatch reactor used for catalyst activity test, and (FIG. 15B) heating setup system.

FIGS. 16A-16B: a structural model of (FIG. 16A) octaphenyl polyhedral oligomeric silsesquioxane (O-POSS) and (FIG. 16B) dodecaphenyl polyhedral oligomeric silsesquioxane (D-POSS).

FIGS. 17A-17B: graphs showing the XRD patterns of (FIG. 17A) O-POSS and their supported catalysts and (FIG. 17B) D-POSS and their supported catalysts.

FIGS. 18A-18F: graphs showing the XPS high-resolution spectra for (FIG. 18A) Si 2p O-POSS, CuZn10-O-POSS90; (FIG. 18B) Si 2p D-POSS, CuZn10-O-POSS90; (FIG. 18C) O 1s O-POSS, CuZn10-O-POSS90, CuO/ZnO; (FIG. 18D) O 1s D-POSS, CuZn10-D-POSS90; CuO/ZnO; (FIG. 18E) Cu 2p CuO/ZnO, CuZn10-D-POSS90, CuZn10-OPOSS90; and (FIG. 18F) Zn 2p CuO/ZnO, CuZn10-D-POSS90, CuZn10-O-POSS90.

FIGS. 19A-19B: graphs showing the (FIG. 19A) ATR FT-IR spectra of O-POSS and CuZn-O-POSS catalysts; and (FIG. 19B) ATR FT-IR spectra of D-POSS and CuZn-D-POSS.

FIGS. 20A-20C: graphs showing the N₂ adsorption-desorption isotherms for (FIG. 20A) O-POSS and their catalysts, (FIG. 20B) D-POSS and their catalysts, and (FIG. 20C) RGO and CuZn10-RGO90.

FIGS. 21A-21B: graphs showing the pore size distribution of (FIG. 21A) O-POSS and its catalysts and (FIG. 21B) D-POSS and its catalysts.

FIGS. 22A-22I: SEM images of (FIG. 22A) CuZn10-O-POSS90, (FIG. 22B) CuZn20-O-POSS80, (FIG. 22C) CuZn30-O-POSS70, (FIG. 22D) CuZn10-D-POSS90, (FIG. 22E) CuZn20-DPOSS80, (FIG. 22F) CuZn30-D-POSS70, (FIG. 22G) graphene oxide (GO), (FIG. 22H) reduced graphene oxide (RGO), and (FIG. 22I) CuZn10-RGO90.

FIGS. 23A-23H: are (FIG. 23A) TEM images of O-POSS, (FIG. 23B, FIG. 23C) TEM images of CuZn10-O-POSS90, (FIG. 23D) a graph of particle size distribution (PSD) of CuZn10-O-POSS90, (FIG. 23E) TEM images of D-POSS, (FIG. 23F, FIG. 23G) TEM images of CuZn10-D-POSS90, and (FIG. 23H) a graph of particle size distribution (PSD) of CuZn10-D-POSS90.

FIGS. 24A-24C show the EDX of (FIG. 24A) 10Cu/ZnO—O-POSS, (FIG. 24B) 10Cu/Zn-D-POSS, and (FIG. 24C) CuZn10-RGO90.

FIGS. 25A-25B: graphs showing the (FIG. 25A) TGA and DTG profiles of O-POSS, their catalysts, and CuO/ZnO. and (FIG. 25B) TGA and DTG profiles of D-POSS, their catalysts, and CuO/ZnO. [Conditions: 10° C./min in N2.]

FIGS. 26A-26B: FIG. 26A is a graph showing contact angle of neat supports and their catalysts before reaction and FIG. 26B is a schematic representation of the D-POSS, O-POSS, and RGO in the presence of water.

FIG. 27 is a graph showing conversion of CO₂ with CuZn10-D-POSS90. Conditions: CO₂:H₂ (1:3) at 2 MPa, 18 h. Catalysts activated at 0.8 MPa, cycled three times with H₂/N₂ at 220° C. for 30 min.

FIGS. 28A-28B: graphs showing the XRD patterns of (FIG. 28A) O-POSS and their supported catalysts; and (FIG. 28B) D-POSS and their supported catalysts in the region 6° to 10.5°.

FIG. 29 is a graph showing the XRD patterns of the CuZn10-RGO catalyst, graphene oxide (GO), and reduced graphene oxide (RGO).

FIGS. 30A-30B: graphs showing the XPS survey spectra (FIG. 30A) O-POSS and CuZn10-O-POSS90; (FIG. 30B) D-POSS and CuZn10-D-POSS90.

FIGS. 31A-31B: graphs showing the XPS High resolution spectra for C 1s (FIG. 31A) O-POSS, CuZn10-O-POSS90; (FIG. 31B) D-POSS, CuZn10-O-POSS90.

FIGS. 32A-32B: graphs showing the XPS high resolution spectra for (FIG. 32A) C 1s for Reduced Graphene Oxide (RGO) and CuZnO10-RGO90; and (FIG. 32B) O 1s for Reduced Graphene Oxide (RGO), CuZnO10-RGO90, and CuO/ZnO.

FIG. 33 is a graph showing the ATR FT-IR spectra of Graphite, Graphite Oxide (GO), Reduced Graphene Oxide (RGO), and CuZn10-RGO90.

FIGS. 34A-34B: a graph showing the (FIG. 34A) TGA and (FIG. 34B) DTG profile for CuO/ZnO, reduced graphene oxide (RGO), and CuZn10-RGO90.

FIG. 35 is a graph showing the ATR-FTIR profile of the spent CuZn10-D-POSS90 after one cycle of reaction.

FIG. 36 is a graph showing the TGA and DTG profile of the spent CuZn10-D-POSS90 after one cycle of reaction.

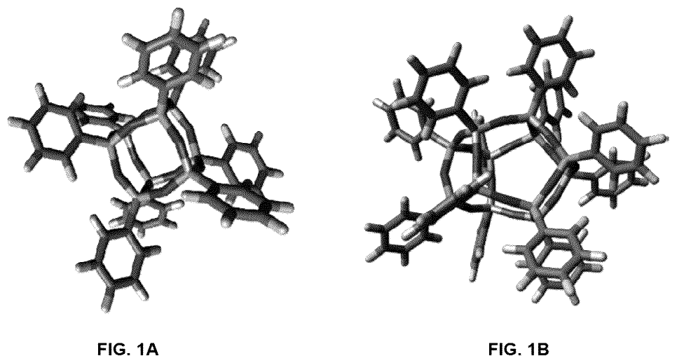

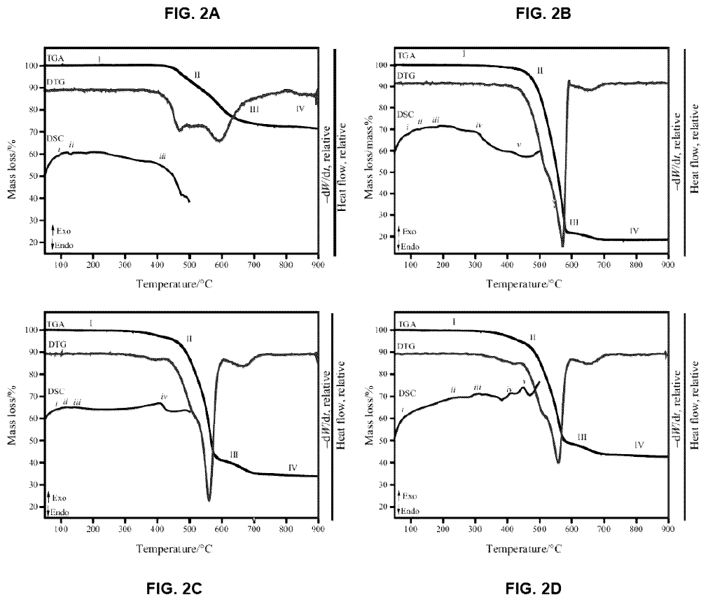

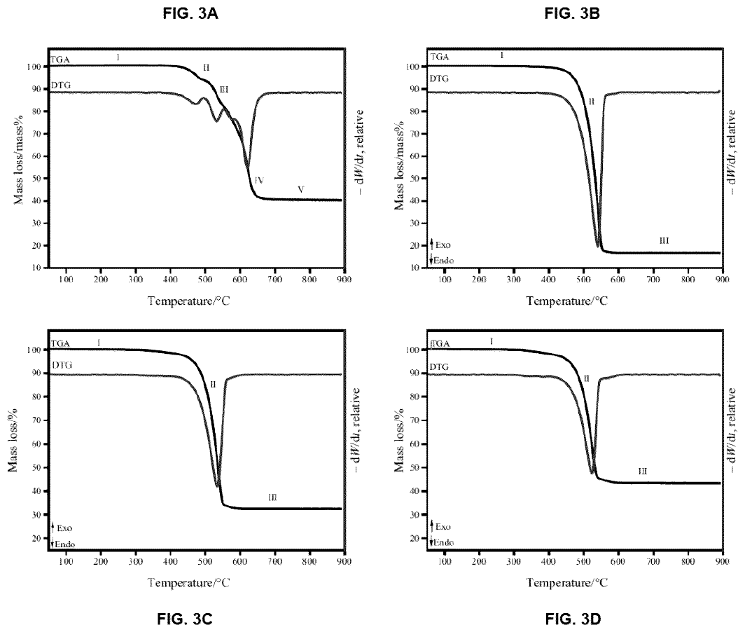

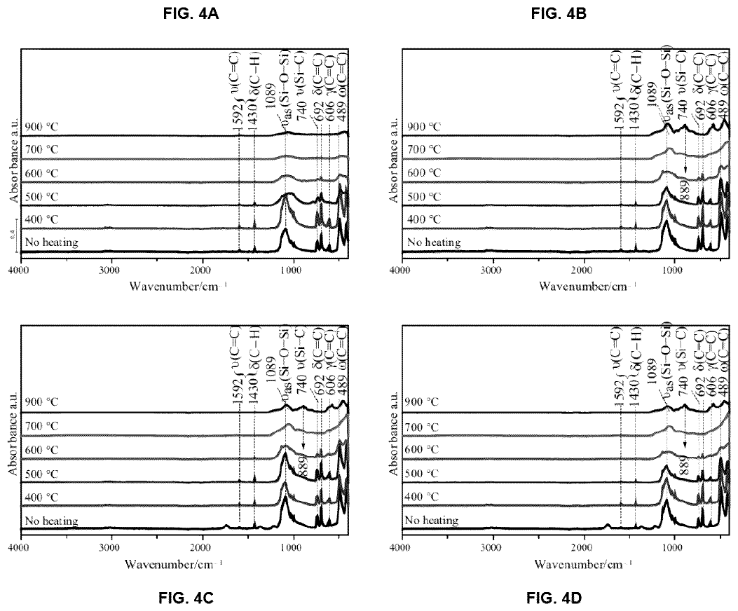

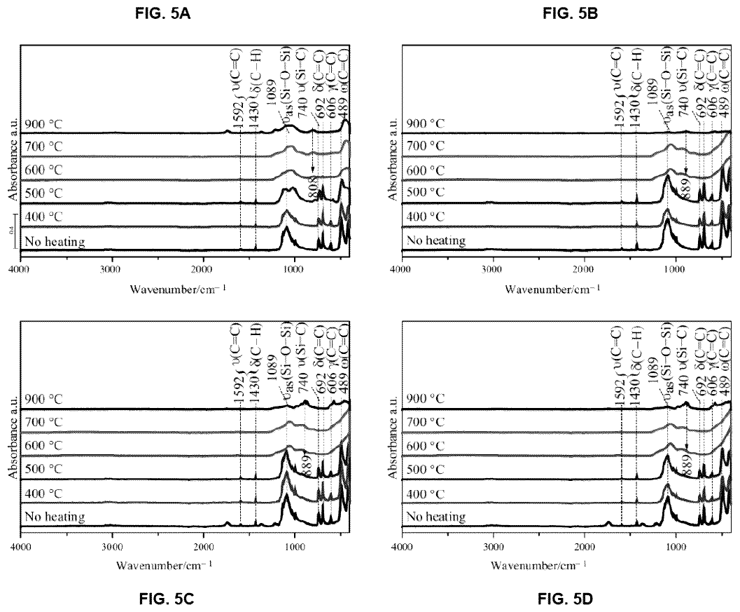

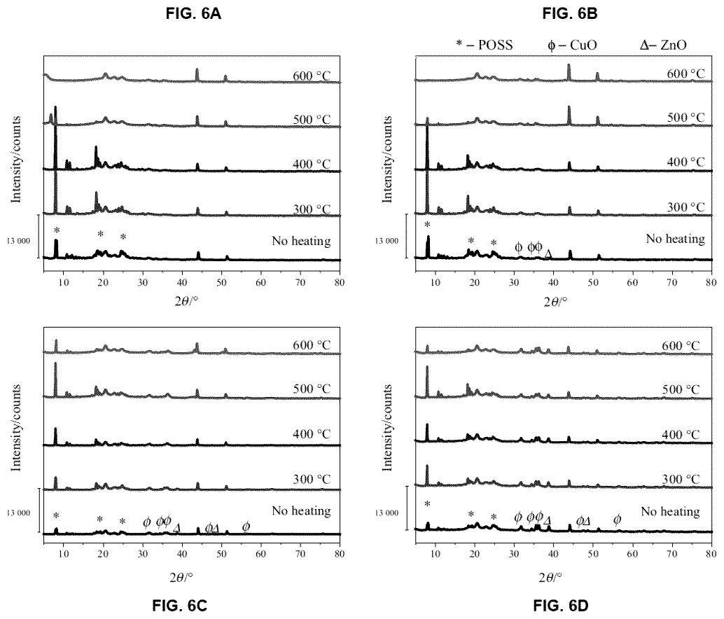

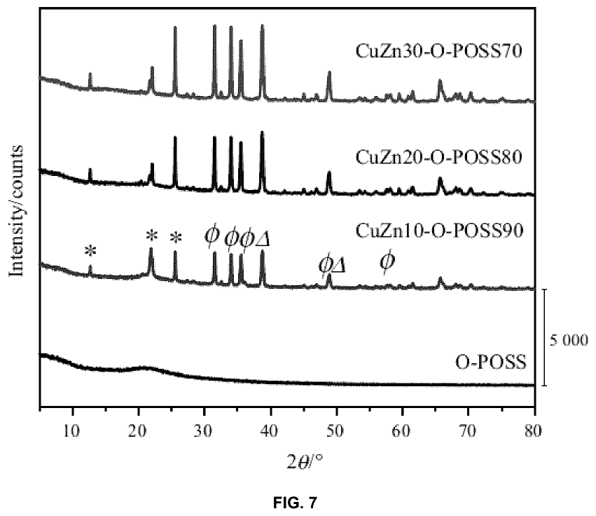

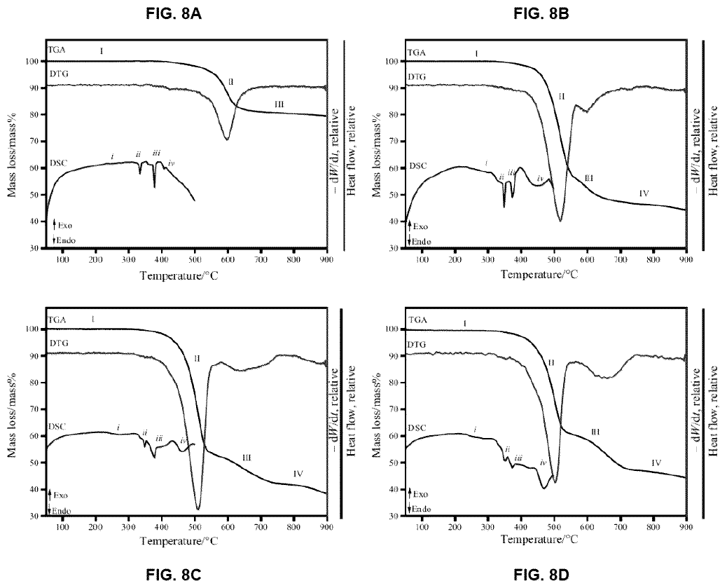

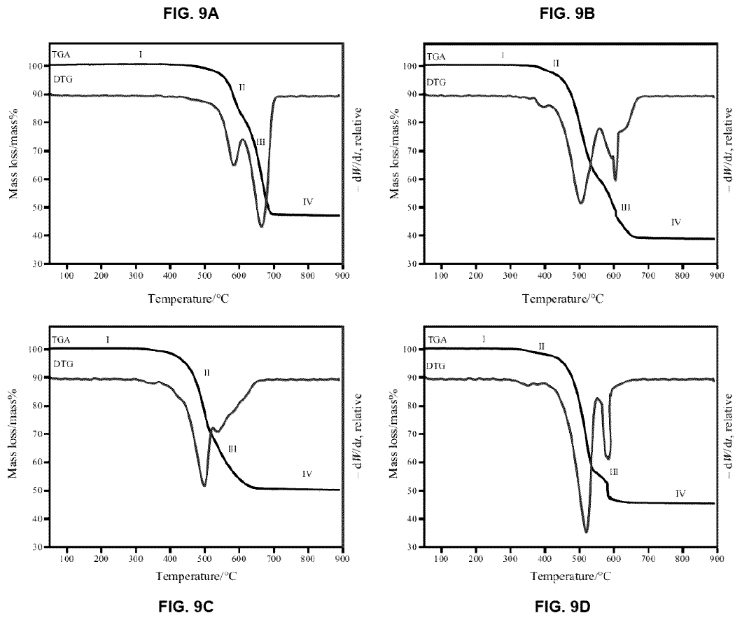

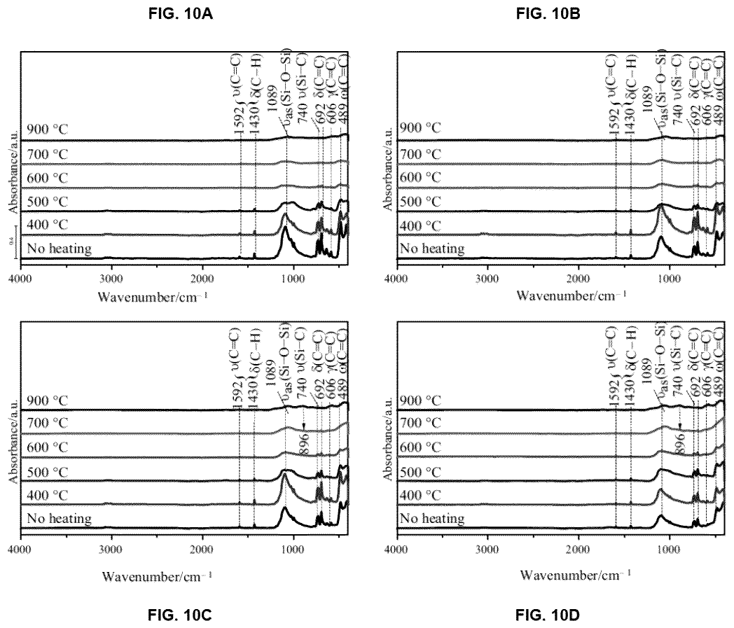

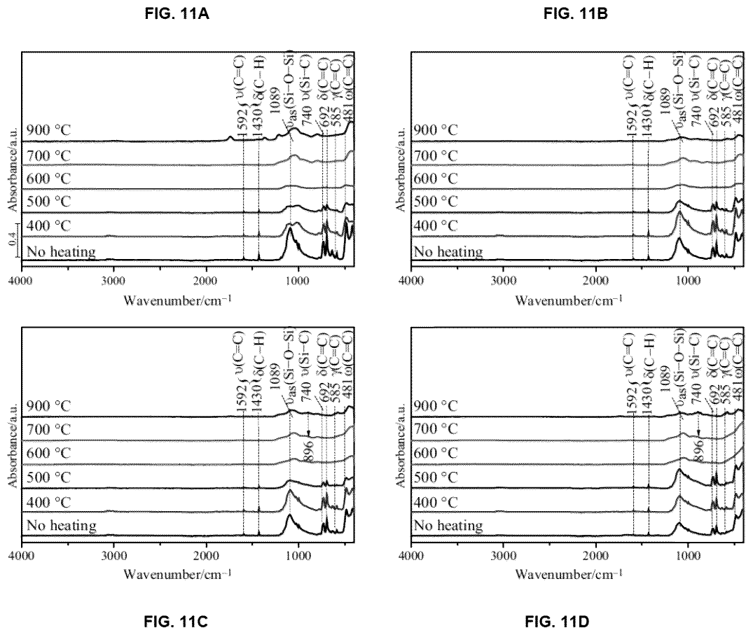

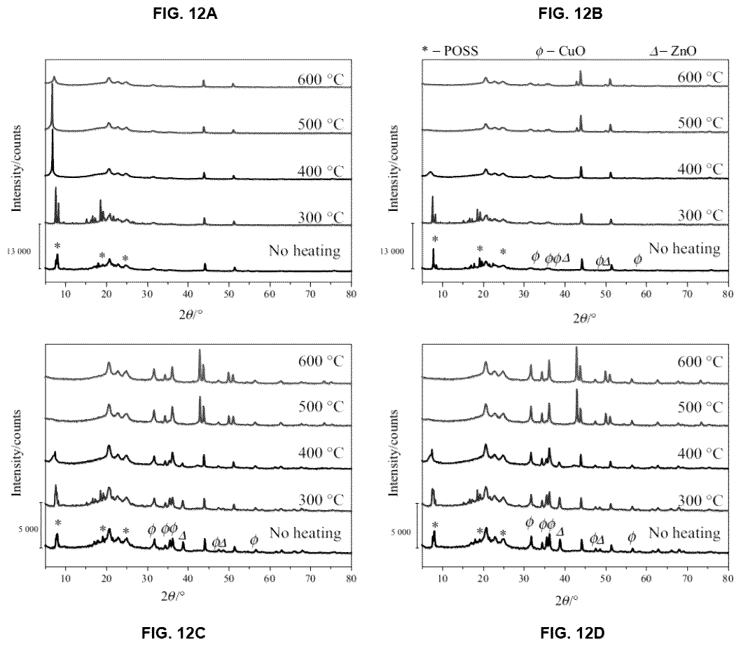

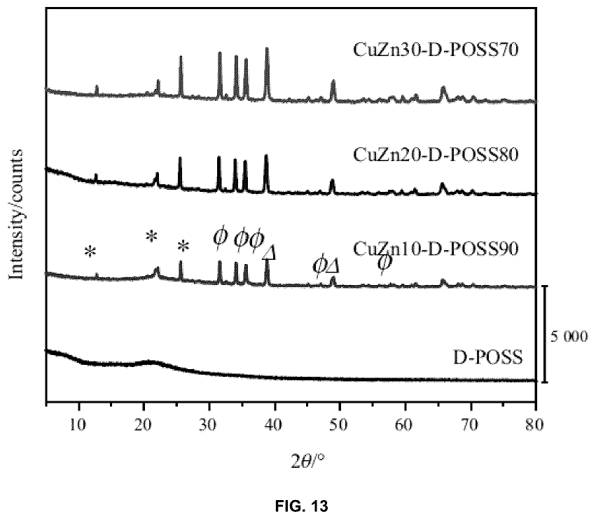

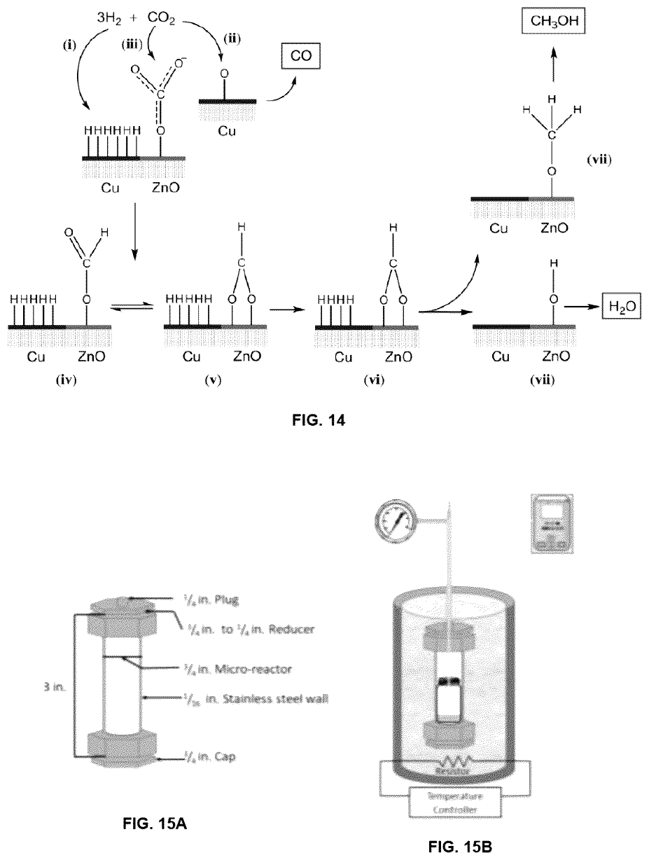

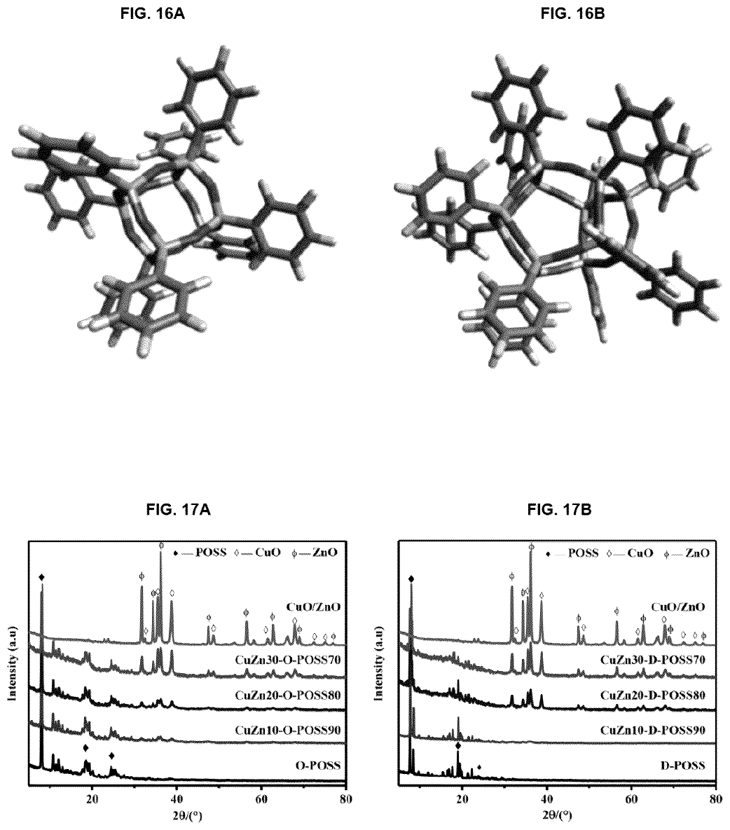

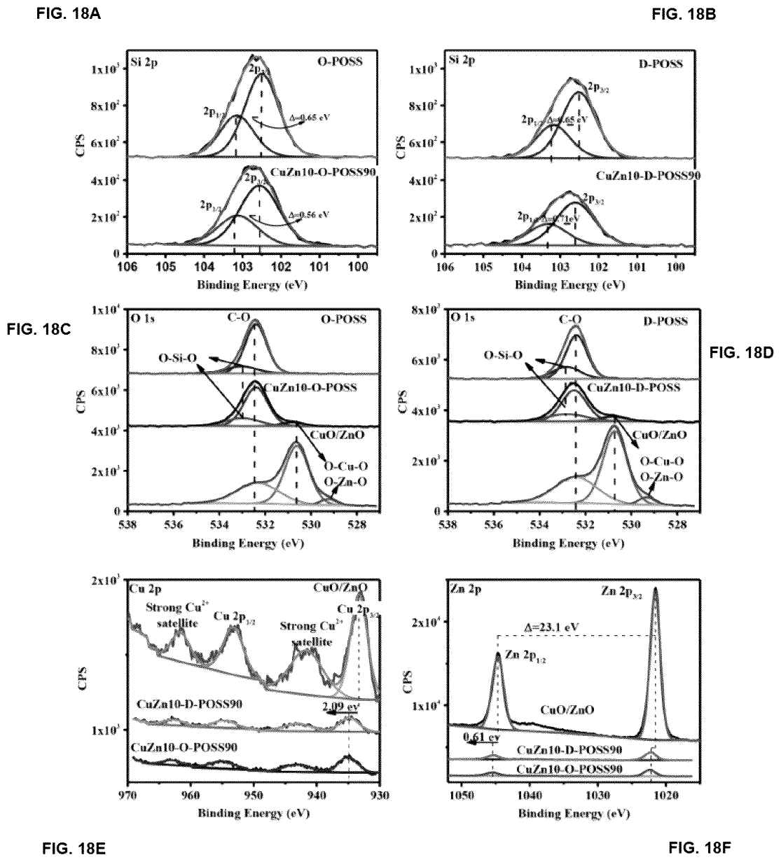

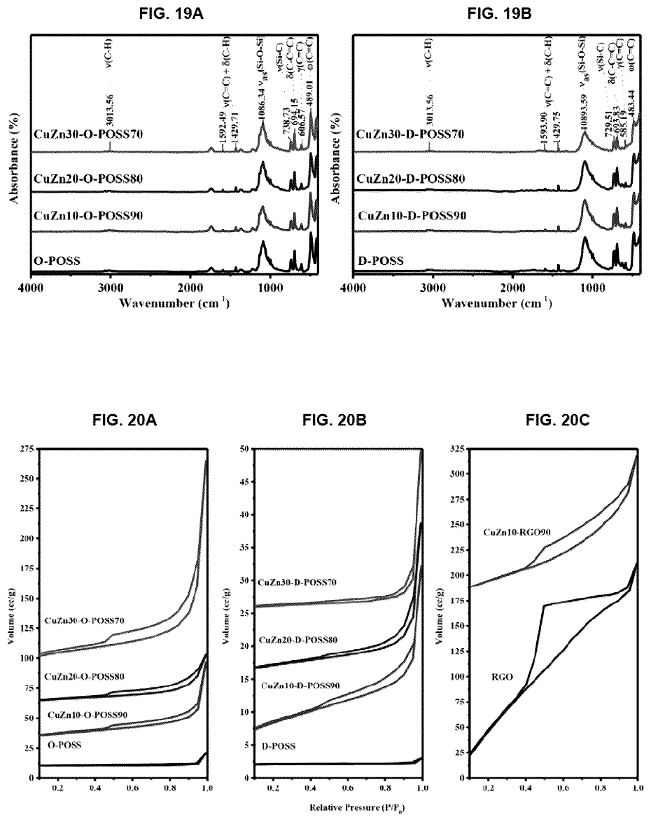

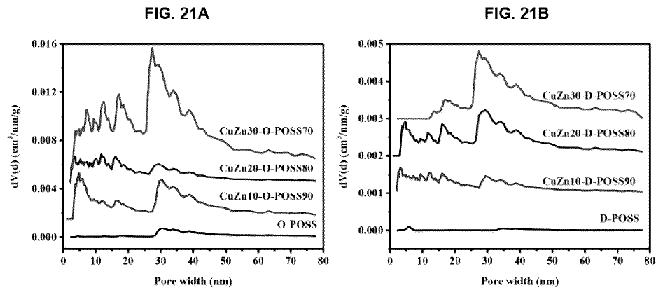

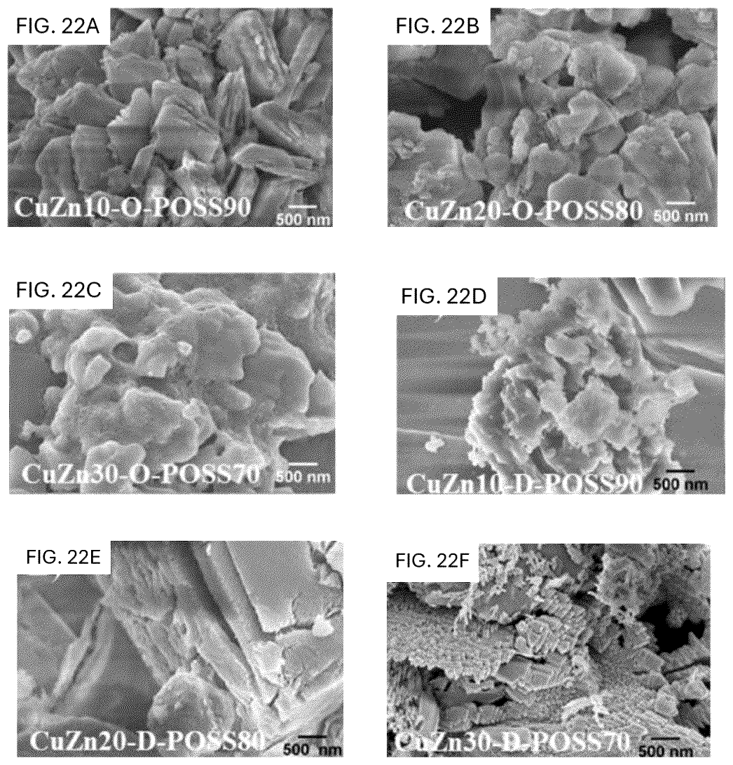

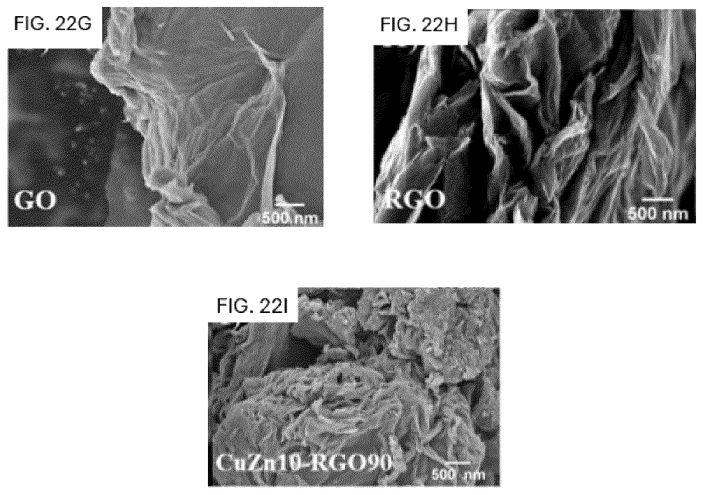

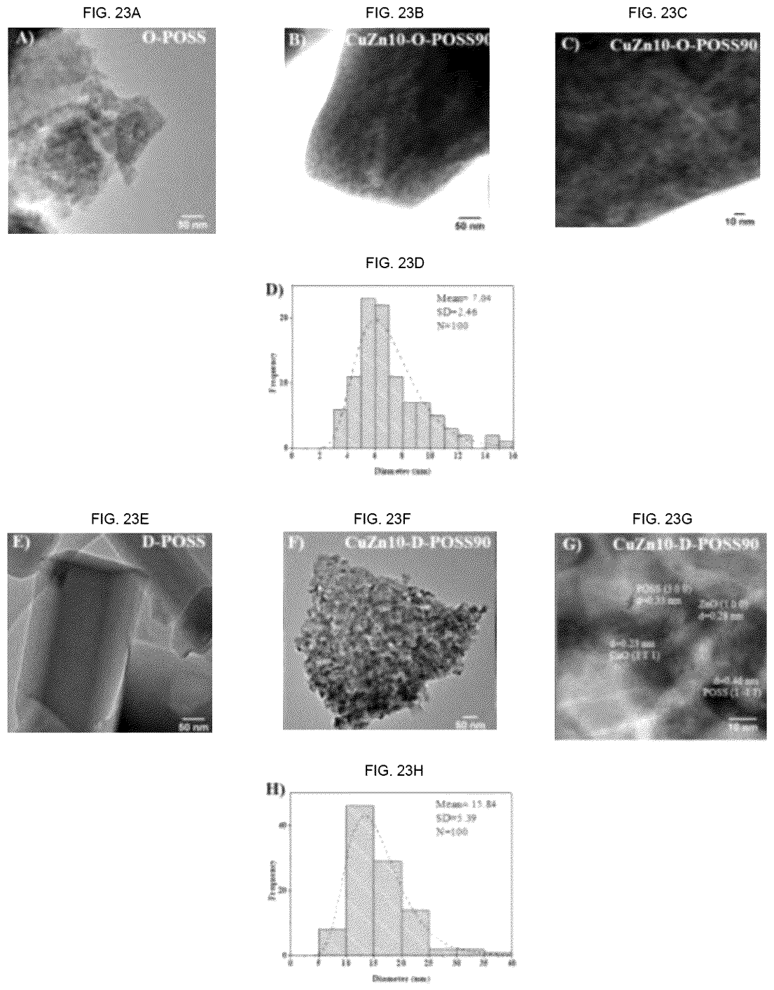

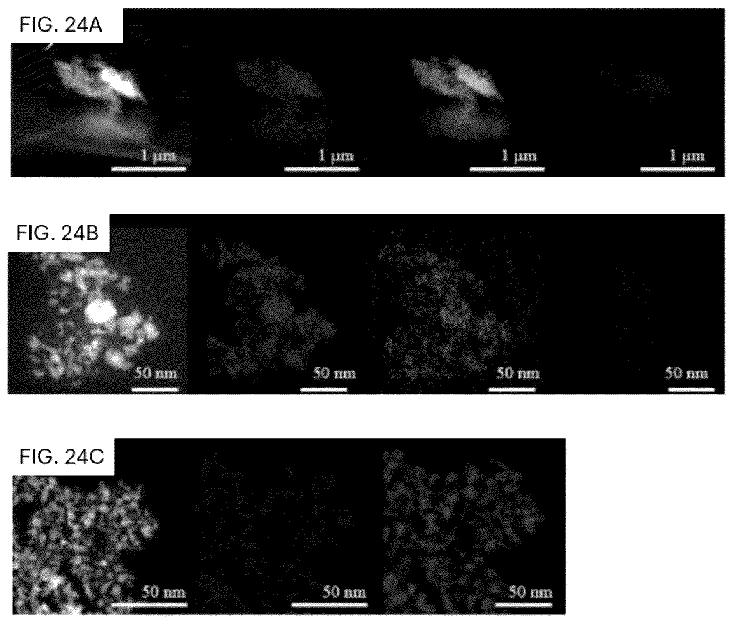

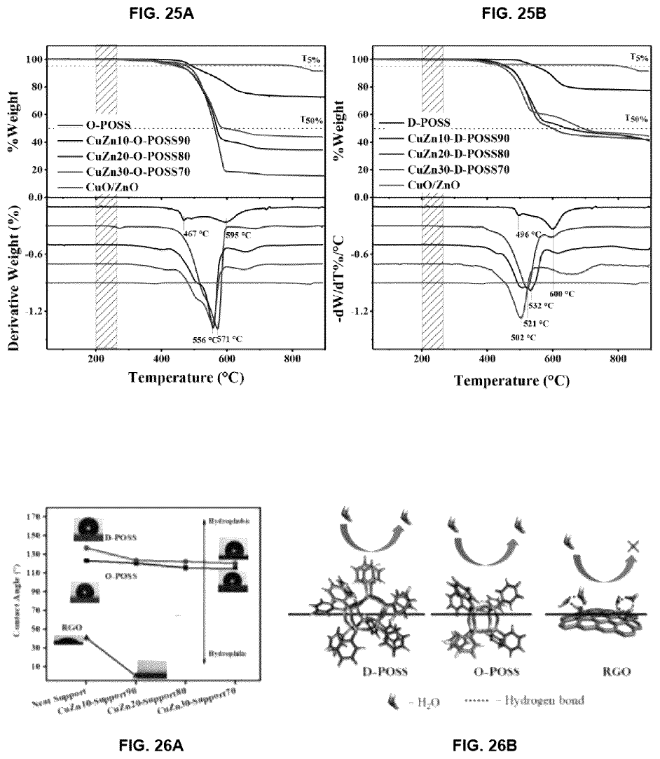

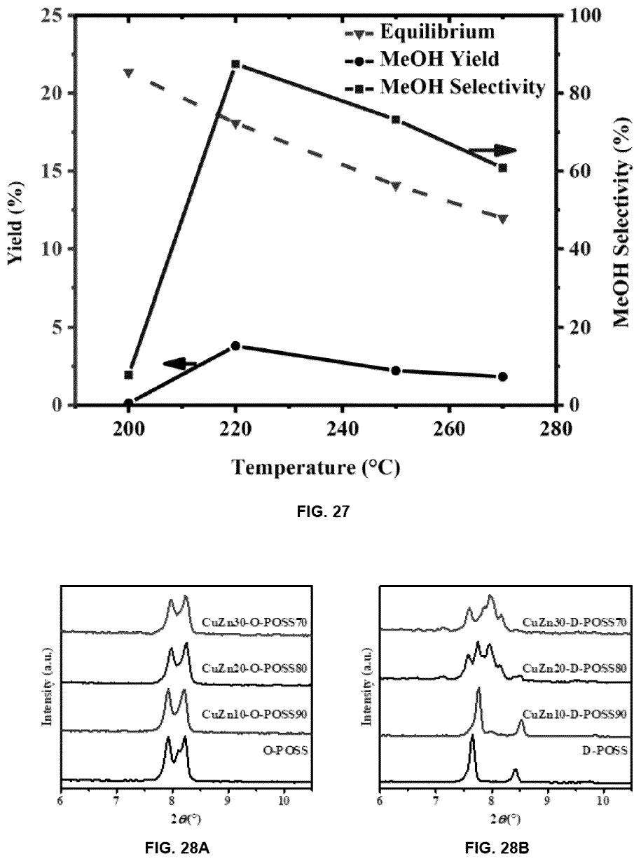

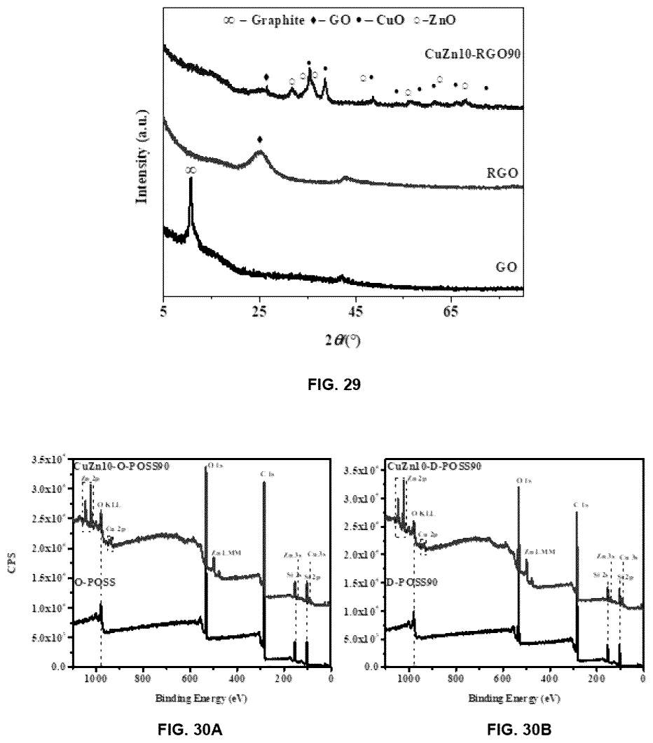

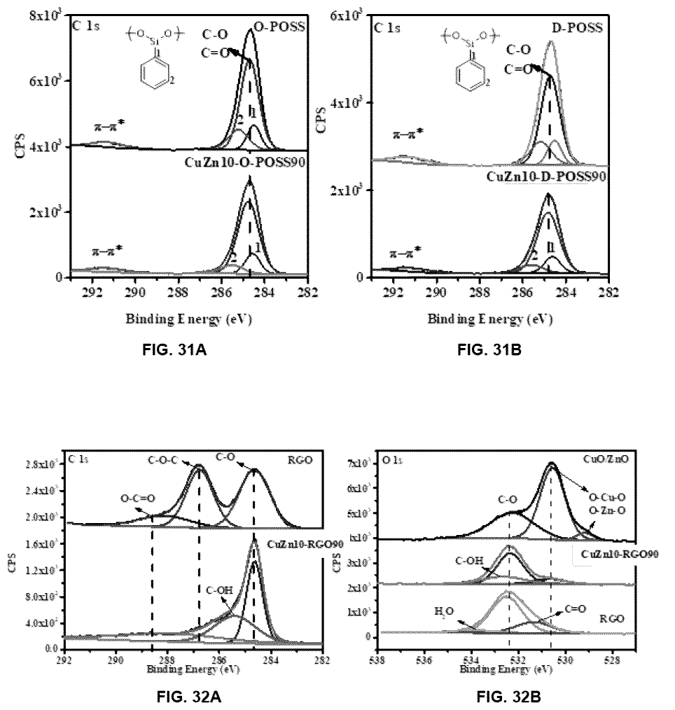

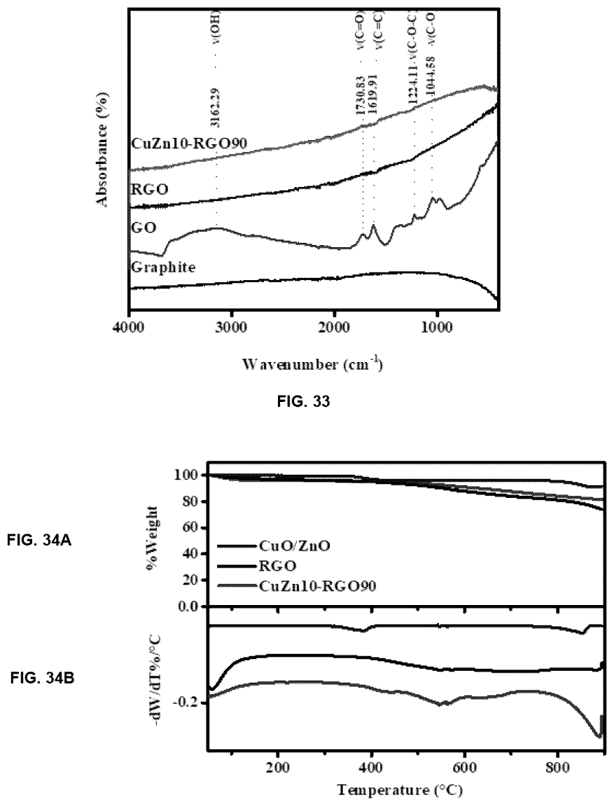

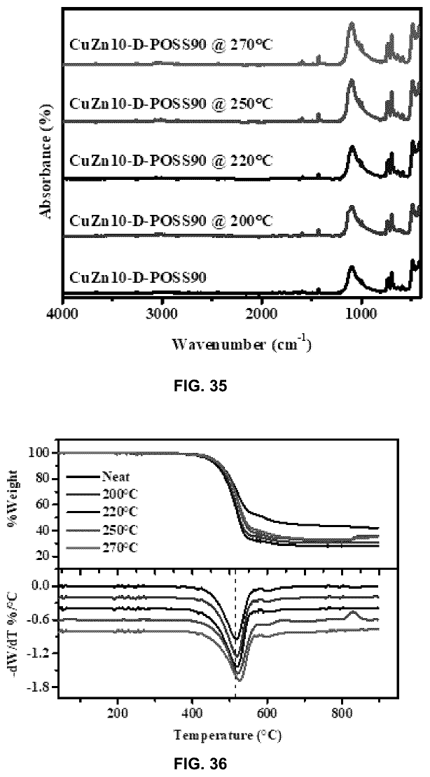

### DETAILED DESCRIPTION

Generally, the present disclosure provides composite materials comprising a phenyl polyhedral oligomeric silsesquioxane (POSS) and one or more metals. The phenyl POSS may be octaphenyl POSS or dodecaphenyl POSS. The metal may be a metal oxide. The composite material may comprise two or more metals. The two or more metals may be present in equivalent molar ratios. The composite material may comprise about 10% to about 30% by mass of the one or more metals. The one or more metals may be a combination of zinc and copper.

In one aspect there is provided a use of the composite material for catalysis. The composite material may be used for catalysis of CO₂ hydrogenation.

In one aspect there is provided a method of forming a composite material comprising insipient wetness impregnation of one or more metals onto a phenyl POSS support.

In one aspect there is provided a method of CO₂ hydrogenation comprising: providing the composite material in a reactor, introducing CO₂ and H₂ to the reactor; and heating the reactor under increased pressure to hydrogenate CO₂.

In one aspect there is provided a use of a phenyl POSS as a catalyst support. In one aspect, there is provided a phenyl POSS loaded with a metal. In one aspect, there is provided a composite material comprising a phenyl POSS and one or more metals. In one aspect, there is provided a use of a phenyl POSS loaded with a metal for catalysis. In one aspect, there is provided a use of a phenyl POSS loaded with Zn and Cu for catalysis of CO₂ hydrogenation. The phenyl POSS may be octaphenyl-POSS or dodecaphenyl-POSS. The metal may be a metal oxide. The metal may be zinc and/or copper.

1. A composite material comprising a phenyl polyhedral oligomeric silsesquioxane (POSS) and a metal.

2. The composite material of claim 1, wherein the phenyl POSS is octaphenyl-POSS or dodecaphenyl-POSS.

3. The composite material of claim 1, wherein the metal is a metal oxide.

4. The composite material of claim 1, comprising two or more metals.

5. The composite material of claim 4, wherein the two or more metals are present in equivalent molar ratios.

6. The composite material of claim 1, comprising about 10% to about 30% by mass of the metal.

7. The composite material of claim 1, wherein the metal comprises zinc and copper.

8. Use of the composite material according to claim 1 for catalysis.

9. Use of the composite material according to claim 7 for catalysis of CO₂ hydrogenation.

10. A method of forming a composite material comprising insipient wetness impregnation of one or more metals onto a phenyl polyhedral oligomeric silsesquioxane support.

11. A method of CO₂ hydrogenation comprising:
providing the composite material according to claim 1 in a reactor;
introducing CO₂ and H₂ to the reactor; and
heating the reactor under increased pressure to hydrogenate CO₂.
